(19) United States
(12) Patent Application Publication
(10) Pub. No.: US 2015/0000178 A1
(43) Pub. Date: Jan. 1, 2015

(54) WEARABLE TRANSPARENT LURE FOR TROLLING

(71) Applicant: Kabushiki Kaisha HOPEC, Ise-shi (JP)

(72) Inventor: Yukio HAMAGUCHI, Ise-shi (JP)

(73) Assignee: Kabushiki Kaisha HOPEC, Ise-shi (JP)

(21) Appl. No.: 14/080,476

(22) Filed: Nov. 14, 2013

(30) Foreign Application Priority Data
Jun. 27, 2013 (JP) 2013-135123

(51) Int. Cl. A01K 85/00

(52) U.S. Cl. CPC A01K 85/00
USPC 43/42.09; 43/42.53

(57) ABSTRACT

A transparent lure includes a bait fish-shaped hollow lure body molded from a transparent thermoplastic elastomer having rubber-like elasticity into a configuration substantially similar to a bait fish. A fish-shaped mouth part of the lure body is formed as a line insertion hole communicating with a mouth part of a bait fish. A posterior half segment of the lure body is cut out, by which the bait fish which has been inserted into the hollow lure body from the cut-out rear end side and the lure body which encloses the bait fish in an anterior half segment are assembled by allowing a line to pass through a mouth part of the bait fish and a line insertion hole of the lure body.

### BACKGROUND OF THE INVENTION

The present invention relates to a wearable transparent lure used in trolling large-size migrant fish, with the lure worn on a bait fish, that is, live bait taken by fish to be caught.

Fish shaped lures molded with a transparent or translucent synthetic resin have been disclosed in Japanese Patent No. 4225395, Japanese Published Unexamined Patent Application No. 2002-34391 and Japanese Published Unexamined Patent Application No. H10-127209. Of these fish shaped lures, the soft lure described in Japanese Patent No. 4225395 is considered to be a publicly known invention which is most approximate to the present invention in that a lure main body thereof is molded with a soft resin into a hollow integrated body, in that a baiting body is filled inside the lure main body which is hollow and in that the lure main body is made transparent or translucent so as to be visually observed for color given on the baiting body from outside.

However, in the publicly known invention disclosed in Japanese Patent No. 4225395, in a process of manufacturing the soft lure, an outer circumferential face of the baiting body in which a plasticizer, fish fat and baiting ingredients favored by fish have been mixed is covered with a soft resin material of the lure main body. Thus, users are unable to use a different baiting body by putting it into or taking it out of the thus manufactured lure main body.

Further, in the above-described soft lure of the publicly known invention, baiting ingredients of the baiting body filled into the lure main body without any void spaces are allowed to flow into the water via an exposed part of the lure main body, thereby gathering fish. As a result, the soft lure is used in a sunken state in the water. In this respect, the lure is used, for example, as a lure for bass angling in lakes and not used in trolling for large-size migrant fish which is perform on the surface of the sea (surface layer) as a fishing place.

Still further, the baiting body is made with a soft resin which is as hard as or softer than the lure main body and colored so as to be different in color from the lure main body. Although the baiting body can be viewed perspectively outside the lure main body, the baiting body is still only an artificial article. The baiting body in itself is not a bait fish which is used as live bait taken by fish to be caught and unable to make an impression on the fish to be caught by swimming real movements of the bait fish, thus resulting in poor fish gathering effects.

On the other hand, the above-described Japanese Published Unexamined Patent Application No. 2012-120496 has disclosed a bait holder which can be attached to use a bait fish (banded blue-sprat). However, this is used for catching cutlass fish and not used in trolling for large-size migrant fish which is performed by allowing a fishing boat to run on the surface of the sea.

Since the bait holder is constituted so that the bait fish is entirely exposed, even if the body of the bait fish is fixed by a hook, the body thereof is damaged in particular by collision with the waves caused when being dragged during trolling, thus always resulting in dropping off of the bait fish.

Further, a line is not guided out or duly connected in the front from a mouth part of the bait fish but in a state of being used by attaching the bait fish to a shaft portion of the hook. Therefore, where the line is pulled during trolling, the bait fish is subjected to rotational movements and unable to give an impression of natural and realistic swimming movements.

The lures disclosed in Patent No. 2002-34391 and Japanese Published Unexamined Patent Application No. H10-127209 are such that a light reflective sheet is pasted on a reflection board which is inserted and installed inside a hollow lure main body and made with a hard synthetic resin, or there are given such processing as hologram processing, laser processing, plating, metal vapor deposition and painting. However, since each of the lures is only a lure (artificial bait) which closely resembles a bait fish (live bait) in terms of external appearance (design) and texture, thus this results in restricted fish gathering effects.

### SUMMARY OF THE INVENTION

An object of the present invention is to give a fundamental solution to the above-described problems. In order to realize the above object, the invention provides, in a first, main aspect thereof, a transparent lure including a hollow lure body which is molded with a transparent thermoplastic elastomer rich in rubber-like elasticity integrally into a configuration substantially similar to a bait fish which is live bait taken by fish to be caught, in which a fish-shaped mouth part of the lure body is formed as a line insertion hole which is communicatively connected to a mouth part of the bait fish, at most a posterior half segment of the lure body is cut out, the bait fish which has been inserted into the hollow lure body from the cut-out rear end side is enclosed at least in an anterior half segment of the lure body, and the bait fish and the lure body are assembled in an integrated manner by allowing a line to pass through the mouth part of the bait fish and the line insert ion hole of the lure body so that the line is duly connected.

Further, a second aspect of the invention is the transparent lure in which at least the anterior half segment of the lure body is elastically and firmly attached to the body of the bait fish.

A third aspect of the invention is the transparent lure in which a vertical slit is made at most on the posterior half segment of the lure body in such a manner that the rear end side of the lure from the vertical slit sways in the lateral direction.

A fourth aspect of the invention is the transparent lure in which at least a caudal fin part, a dorsal fin part and an anal fin part are allowed to protrude continuously in an integrated manner from the lure body and the fin parts are surface-treated so as to give parallel linear irregularities, intersecting linear irregularities or satin-like irregularities in which dots are scattered.

A fifth aspect of the invention is the transparent lure in which a line to which a hook has been attached integrally at the rear end thereof is allowed to pass from the cut-out rear end side of the lure body through the body of the bait fish into the line insertion hole of the lure body so that the line is duly connected, and only the sharp leading-end side of the hook is allowed to protrude partially outside the lure body.

Still further, A sixth aspect of the invention is the transparent lure in which a line to which a hook has been attached integrally at the rear end thereof is allowed to pass from the cut-out rear end side of the lure body through a gill part of the bait fish, the mouth part thereof and the line insertion hole of the lure body so that the line is duly connected, and only the sharp leading-end side of the hook is allowed to protrude partially outside the lure body.

According to the configuration of the first aspect of the invention, the bait fish which is live bait taken by fish to be caught is inserted and set inside the hollow transparent lure body and enclosed in the lure body. Therefore, the transparent lure is free of such fear that the bait fish is damaged to collapse at an early stage by collision with waves while being pulled and dragged in trolling. Moreover, the bait fish can be effectively kept fresh and alive for a prolonged period of time.

Further, the lure body which encloses the bait fish is molded with a thermoplastic elastomer rich in rubber-like elasticity and undergoes elastic deformation together with the bait fish. Thus, the bait fish is able to greatly stimulate the bait searching instinct of fish to be caught in combination with the fact that the bait fish can be viewed perspectively outside the lure body, thereby providing excellent fish gathering effects.

In particular, if the configuration according to the second aspect of the invention is adopted, the bait fish and the lure body which encloses the bait fish are elastically and firmly attached and formed into an intergrated body to a greater extent. As a result, the transparent lure is able to cover and protect the bait fish and also give an impression of real swimming movements as if only real (natural) live bait moves as it is, which is effective in improvement in fish gathering effects.

Further, if the configuration according to the third aspect of the invention is adopted, as a method for cutting out at most the posterior half segment of the lure body, the vertical slit is made internally, thereby, in particular, the caudal fin part of the rear end side from the vertical slit is allowed to sway freely in the lateral direction. This is also able to greatly stimulate the bait searching instinct of the fish to be caught.

The transparent lure of the present invention is used for trolling of large-size migrant fish and dragged on the surface of the sea (surface layer). Upon receipt of light, the transparent lure body glistens and shimmers. If the configuration of the fourth aspect of the invention in particular is adopted, the irregularities given to the caudal fin part, the dorsal fin part and the anal fin part of the fish shaped lure body also reflect light and glisten and shimmer upon receipt of the light. This is more effective in gathering fish to be caught and greatly contributes to angling results.

If the configuration of the fifth aspect of the invention is adopted, in a state that the line to which the hook has been attached is penetrated through the body of the bait fish, at least the anterior half segment of the bait fish is enclosed in the transparent lure body and only the sharp leading-end side of the hook is allowed to protrude partially outside the lure body. Thus, this is effective in allowing the fish to be caught to bite a bait fish without having a sense of caution, sense of discomfort and the like, due to its external appearance.

Further, if the configuration of the sixth aspect of the invention is adopted, the line is allowed to pass from the gill part of the bait fish via the mouth part thereof into the line insertion hole which is the mouth part of the lure body and guided out and duly connected in the front from the lure body. Since there is no fear that the bait fish may be damaged, the bait fish can be effectively kept fresh and alive for a prolonged period of time.

### BRIEF DESCRIPTION OF THE DRAWINGS

FIG. 1 is a side view of a wearable transparent lure of the present invention which is used in trolling.

FIG. 2 is a plan view of FIG. 1.

FIG. 3 is a sectional view taken along the line 3 to 3 in FIG. 1.

FIG. 4 is a sectional view taken along the line 4 to 4 in FIG. 2.

FIG. 5 is a sectional view taken along the line 5 to 5 in FIG. 1.

FIG. 6 is a sectional view taken along the line 6 to 6 in FIG. 1.

FIG. 7 is a plan sectional view which shows a process in which a bait fish is inserted into a hollow lure body.

FIG. 8 is a side sectional view of FIG. 7.

FIG. 9 is a side sectional view which corresponds to FIG. 8 showing that the bait fish is inserted and set inside the hollow lure body.

FIG. 10 is a side view which shows a state that a relatively large bait fish is inserted and set into the hollow lure body.

FIG. 11 is a side view which shows a state that a relatively small bait fish is inserted and set inside the hollow lure body.

FIG. 12 is a side view which shows a state that a bait fish substantially similar in dimension to the lure body is inserted and set inside the hollow lure body.

FIG. 13 is a sectional view taken along the line 13 to 13 in FIG. 12.

FIG. 14 is a sectional view taken along the line 14 to 14 in FIG. 13.

FIG. 15 is a sectional view taken along the line 15 to 15 in FIG. 14.

FIG. 16 is an overall schematic side view which explains trolling in which the present invention is used for catching fish to be caught (tuna).

FIG. 17 is an enlarged view which shows a part of P1 in FIG. 16 by being extracted.

FIG. 18 is a perspective view which shows a resistance board by being extracted from FIG. 16.

FIG. 19 is an enlarged view which shows a part of P2 in FIG. 16 by being extracted.

FIG. 20 is an enlarged view which shows a part which supports a boat rod by a vessel body by being extracted from FIG. 16.

### DETAILED DESCRIPTION OF THE INVENTION

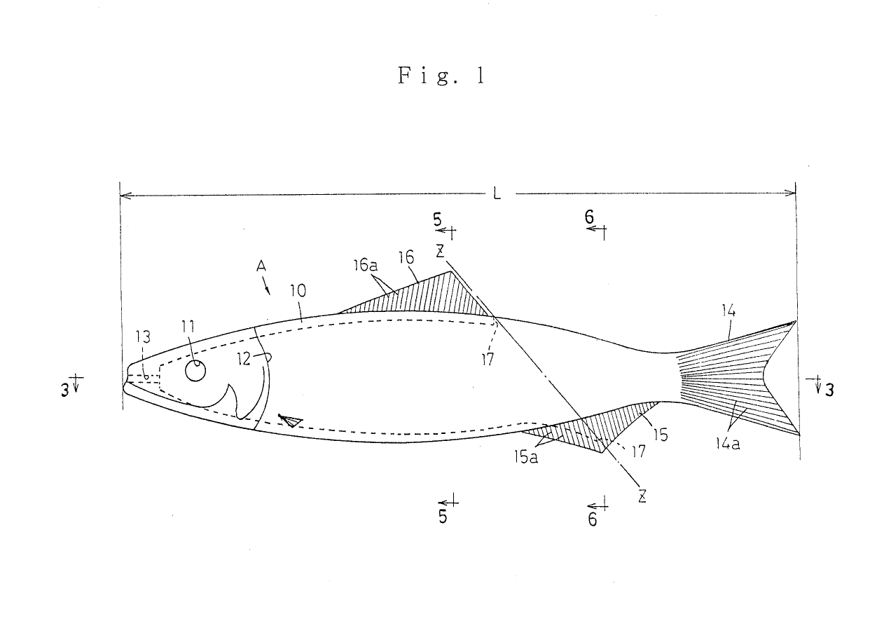

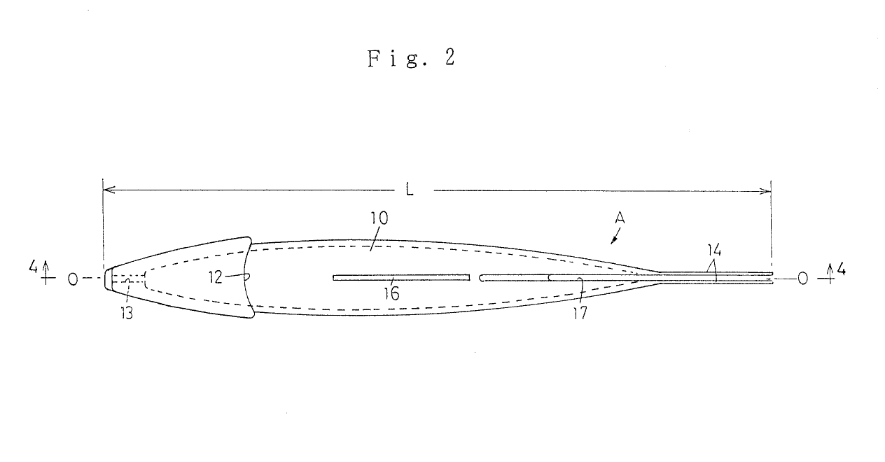

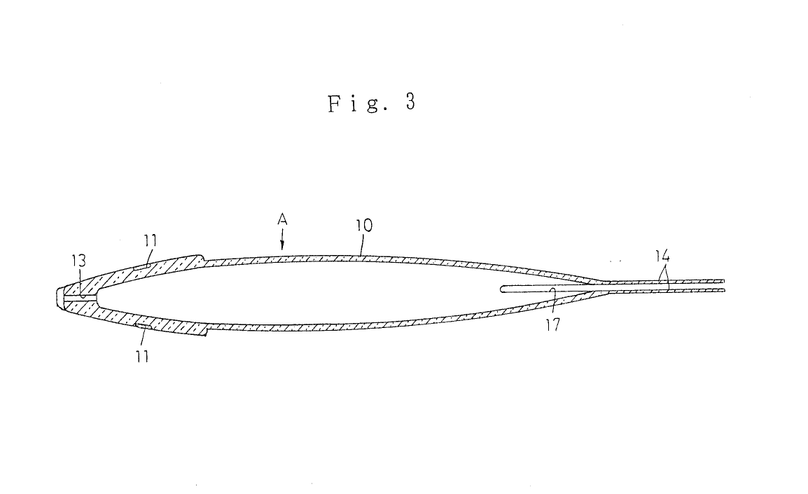

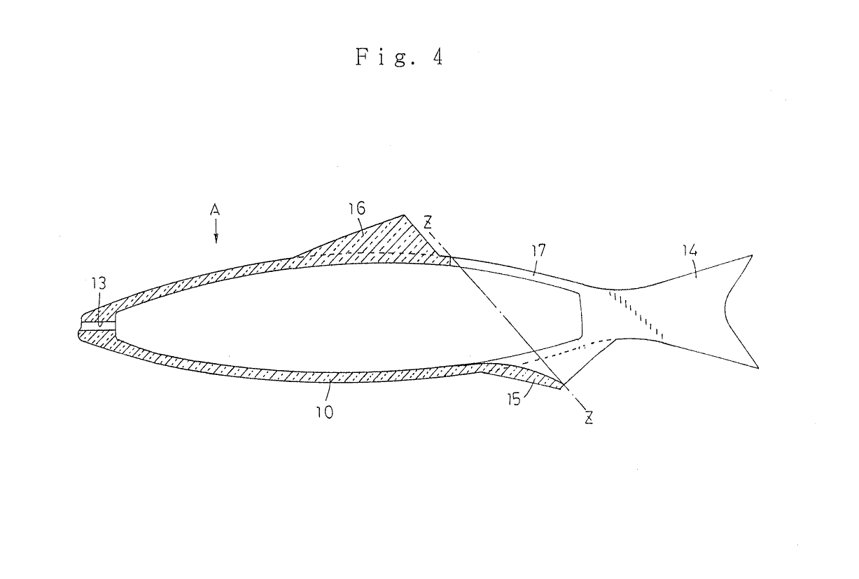

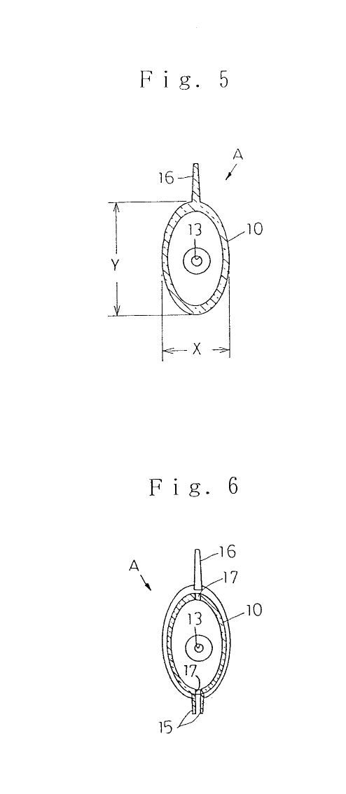

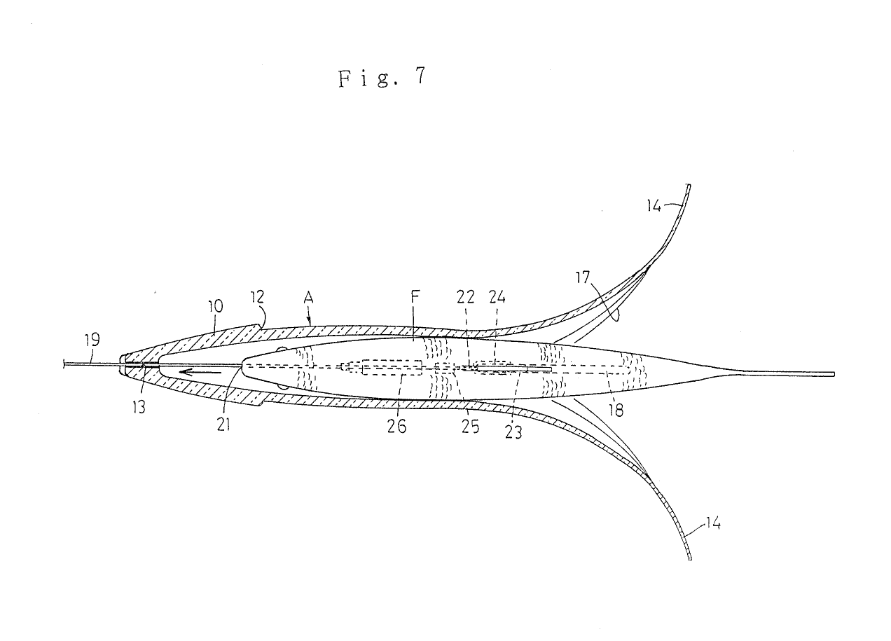

Hereinafter, a detailed description will be given for preferred embodiments of the present invention with reference to drawings. A transparent lure (A) appropriately used in trolling for tuna (fish to be caught) is shown in FIG. 1 to FIG. 6. A reference numeral (10) indicates a hollow lure body which is injection-molded with a transparent thermoplastic elastomer (TPE) having rubber-like elasticity into a configuration (for example, streamline shape) which roughly resembles a bait fish or live bait taken by the fish to be caught.

In the illustrated embodiment, the bait fish is configured so as to roughly resemble a sardine. However, the bait fish may be configured to assume the shape of another fish such as mackerel. In either case, it is possible to spray powder (not illustrated) on the surface (outer face) of the lure body (10) for preventing the lure body (10) from being adhered to other objects. As a matter of course, the powder will flow away together with water, by which the lure body (10) is made transparent.

Further, the thermoplastic elastomer (TPE) with which the lure body (10) is made includes olefin-based, styrene-based, acryl-based, polyester-based and vinyl chloride-based elastomers in a broad sense. Particularly preferable are those high in transparency, weather resistance, flexibility and retractility (for example, acryl-based thermoplastic elastomers and styrene-based thermoplastic elastomers).

A symmetrical pair of circular recessed step parts (11) acting as eyes and circular gill cover parts (12) rising toward the surface (outside) are provided on the front head side of the fish shaped lure body (10). Further, a line insertion hole (13) which acts as the fish shaped mouth part is penetrated and formed so as to be communicatively connected to the hollow lure body (10).

On the other hand, a caudal fin part (14) and an anal fin part (15) are allowed to continuously protrude respectively backward and obliquely downward in an integrated manner from the rear end side of the lure body (10). A reference numeral (16) indicates a dorsal fin part which is also allowed to protrude continuously in an integrated manner substantially from an intermediate position of the lure body (10) upward. Satin-like irregularities where dots are scattered, intersecting linear irregularities or parallel linear irregularities (14a), (15a), (16a) are given on the surfaces (outer faces) of the caudal fin part (14), the anal fin part (15) and the dorsal fin part (16). The lure is able to glisten and shimmer by reflecting light shed on these surfaces in combination with the fact that it is transparent.

Further, the rear end side from a virtual line (Z-Z) which connects the vicinity of a rear-end position at the dorsal fin part (16) with the vicinity of an intermediate position at the anal fin part (15) in the lure body (10) is cut out for inserting and setting a bait fish (F) which is live bait for fish to be caught (tuna).

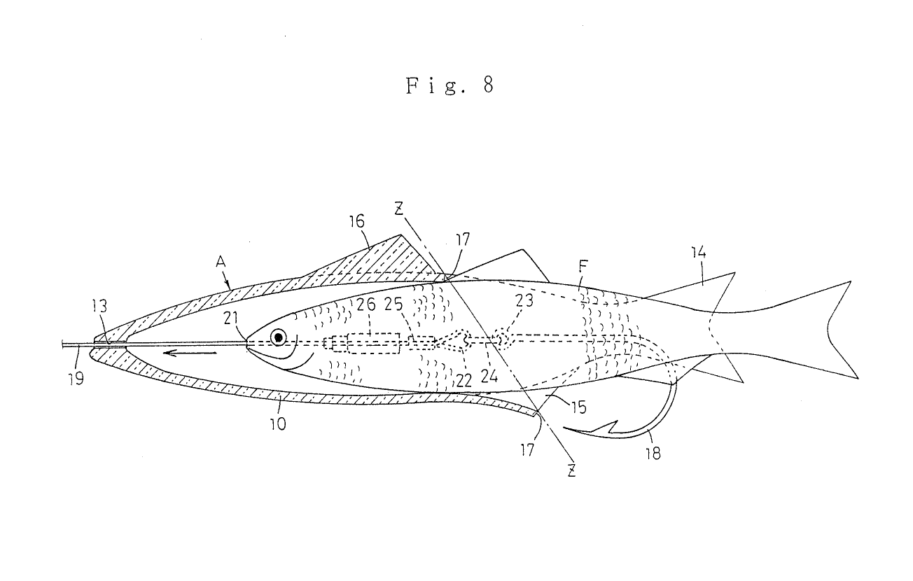

The lure body (10) cut out for inserting and setting the bait fish (F) is preferably cut as a vertical slit (17) as illustrated in the embodiment. Thereby, the rear end side from the virtual line (Z-Z) of the lure body (10) can be divided in the lateral direction above a longitudinal center line (O-O) of the lure body (10) as shown in FIG. 7. While being used, the rear end side of the lure body (10) including the caudal fin part (14) sways freely in the lateral direction, thereby giving an impression that the bait fish (F) swims naturally.

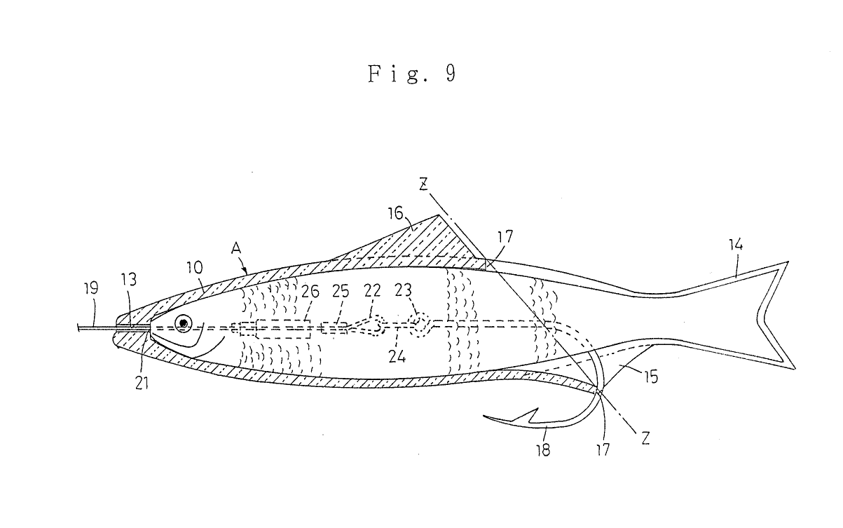

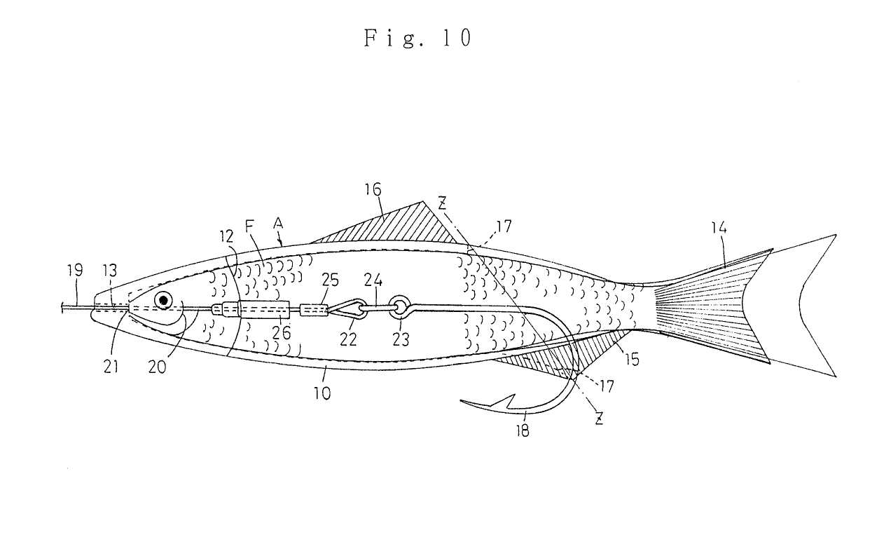

Each of FIG. 7 and FIG. 8 shows a process in which the bait fish (F) is inserted into the hollow lure body (10) from the rear end side at which the vertical slit (17) is cut and kept open. The thus inserted and set bait fish (F) on the front head side from the virtual line (Z-Z) of the lure body (10) is, as shown in FIG. 9, kept completely enclosed at 360 degrees.

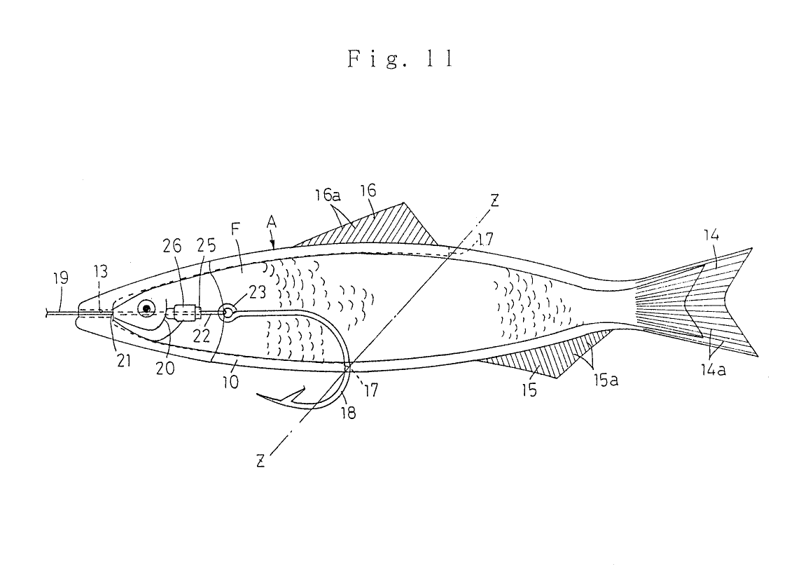

In this case, in FIG. 7 to FIG. 9, the bait fish (F) which is substantially similar in dimension to the lure body (10) is inserted and set inside the hollow lure body (10). In FIG. 10, the bait fish (F) which is greater in dimension is inserted and set inside the hollow lure body (10).

Next, in either case, the lure body (10) is kept elastically and firmly attached to the bait fish (F) at a relatively large area which occupies the front head side from the virtual line (Z-Z) of the lure body (10), by which the bait fish (F) and the lure body (10) which encloses the bait fish are increased in integral formation.

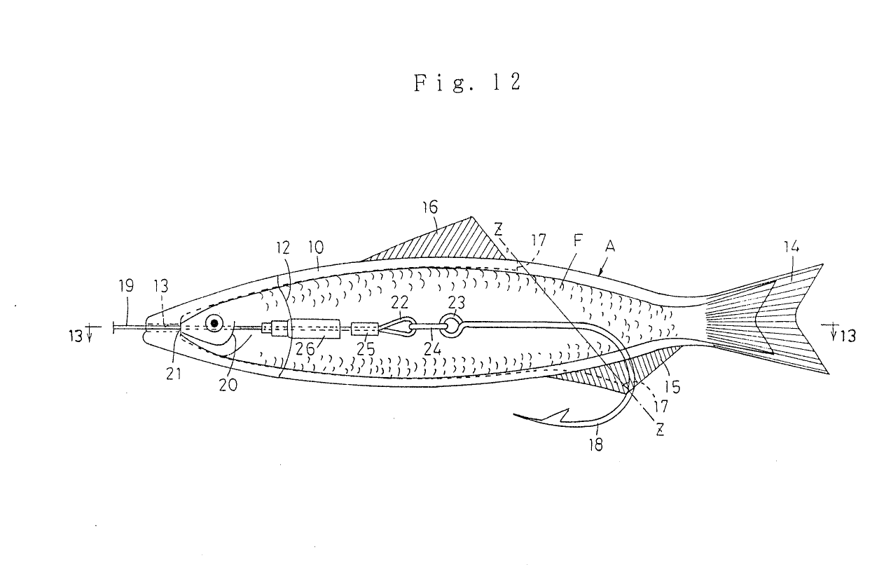

However, as shown in a modified embodiment of FIG. 11 corresponding to FIG. 9 and FIG. 10, it is acceptable that the body of the bait fish (F) is kept enclosed at least in the anterior half segment of the lure body (10) even where the bait fish (F) smaller than the lure is inserted into the rear end side of the hollow lure body (10) which is kept open. The bait fish (F) and the lure body (10) which encloses the bait fish (F) are assembled in an integrated manner via a line to be described later, and there is no fear that the bait fish (F) will be detached while in use.

In other words, as illustrated in the modified embodiment of FIG. 11, it is also acceptable that the rear end side from a virtual line (Z-Z) which connects the vicinity of a rear-end position at the dorsal fin part (16) in the lure body (10) with the vicinity of an intermediate position at a ventral part (the thickest part of waistline) is kept open by being cut by the vertical slit (17).

In relation to the body of the bait fish (F) which is enclosed at least in the anterior half segment of the lure body (10), the lure body (10) is cut out in such an occupied area that the bait fish (F) can be inserted and set at most only in the posterior half segment of the lure body (10).

Further, since the lure body (10) is made of a thermoplastic elastomer (TPE) having rubber-like elasticity, it is able to change in dimension and configuration of the bait fish (F) which is inserted and set inside the hollow lure body (10). Moreover, the lure body (10) is able to undergo elastic deformation freely and move in synchronization with the bait fish (F), which is quite effective in gathering fish to be caught (tuna).

That is, the transparent lure (A) configured to resemble a sardine which is taken by tuna (fish to be caught) in the illustrated embodiment is, for example, an M-size lure, as a dimensional standard. More particularly, the lure is about 225 mm in entire length (L) from the mouth part of the lure body (10) to the caudal fin part (14), about 45 mm in long-axis length (height) (Y) at the thickness part of the lure body (10) having a substantially oval cross section, about 30 mm in short-axis length (width) (X), and about 3 mm to 4 mm in thickness (T) on average.

In using the above-described transparent lure (A), as shown in FIG. 7 and FIG. 8, there is realized such a state that the bait fish (sardine) (F) which is live bait for fish to be caught (tuna) is inserted and set into the hollow lure body (10) from the rear end side of the lure body (10) which is cut out by the vertical slit (17) and the bait fish (F) is enclosed at least in the anterior half segment of the lure body (10).

In this respect, FIG. 9 shows a state that the bait fish (F) is enclosed in a relatively large occupied area of the front head side of the lure body (10) from the virtual line (Z-Z). However, in reality, a line (19) to which the hook (18) has been tied in advance at the leading end (rear end) thereof is, as shown in FIG. 7 and FIG. 8, penetrated through the body of the bait fish (F) and the mouth part (21) thereof. Moreover, the line (19) is guided out and duly connected in the front from the line insertion hole (13) which acts as the mouth part of the lure body (10) and also the hook (18) is, as shown in FIG. 9, locked in an open lower edge of the vertical slit (17), by which only the sharp leading-end side of the hook (18) is positioned and set so as to partially protrude outside the lure body (10). In this case, although not being illustrated, the body of the bait fish (F) may be in advance subjected to processing for due connection such as drilling and notch.

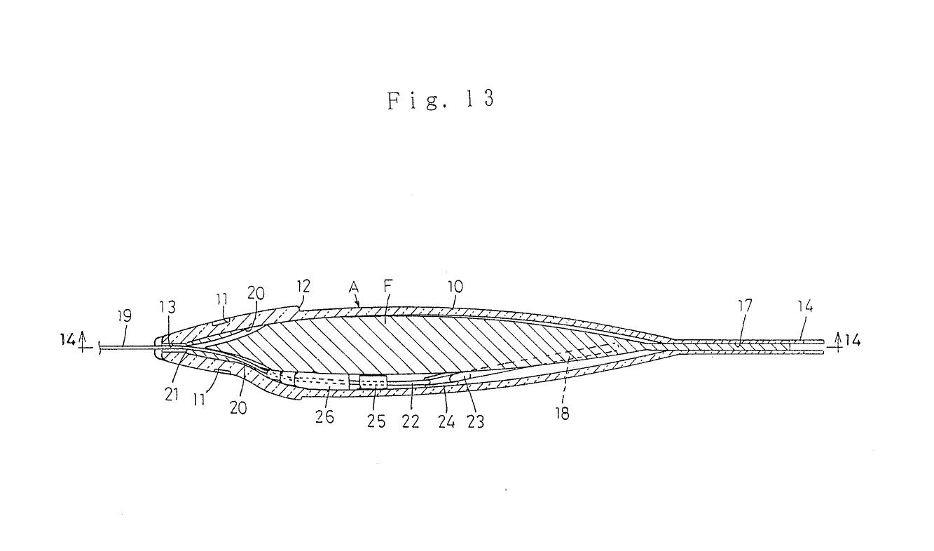

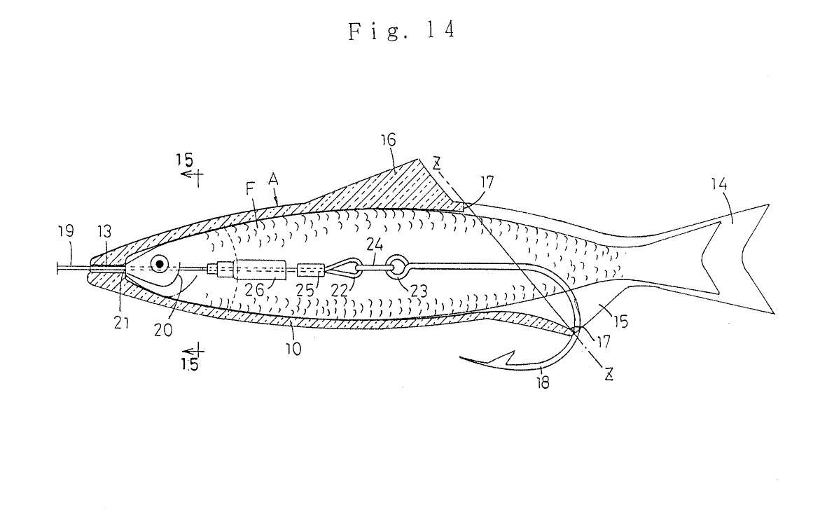

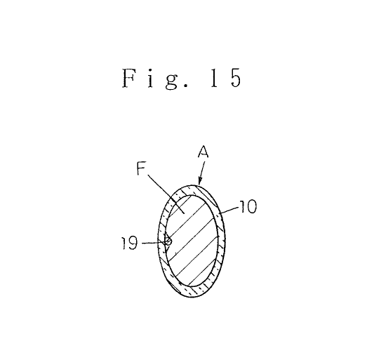

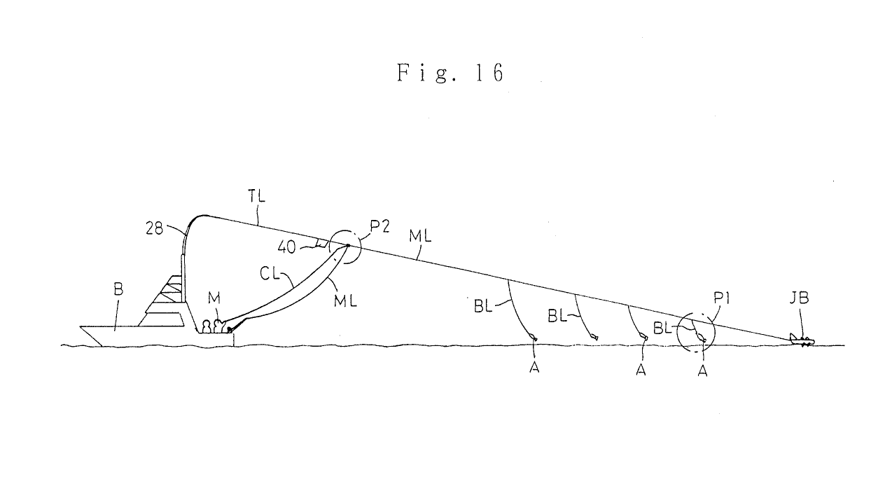

In place of the method in which the line (19) is allowed to pass through the bait fish (F) and duly connected as shown in FIG. 7 to FIG. 9, it is acceptable that the line (19) having the hook (18) tied in advance at the leading end (rear end) is not allowed to pass through the body of the bait fish (F) as shown in the modified embodiment shown in FIG. 12 to FIG. 15 but allowed to pass from the gill part (20) of the bait fish (F) via the mouth part thereof (21) into the line insertion hole (13) which is the mouth part of the lure body (10) through a space between the outside of the body of the bait fish and the inside of the lure body (10) so that the line is duly connected, then, the line (19) is guided out in the front from the line insertion hole (13) of the lure body (10) to receive the hook (18) at the open lower edge of the vertical slit (17), thereby only the sharp leading-end side is positioned and set so as to protrude partially outside the lure body (10).

Accordingly, in any of the above-described methods for duly connecting the line, the bait fish (F) and the lure body (10) which encloses the bait fish are assembled in an integrated manner via the line (19) so as not to be detached from each other. Further, the lure body (10) is not only light in weight and has rubber-like elasticity but also undergoes elastic deformation freely as if giving an impression that the bait fish (F) swims naturally. Moreover, the rear end side from the vertical slit (17), in particular, the caudal fin part (14) also sways laterally. Thus, there are provided actions of effectively gathering fish to be caught (tuna).

In particular, if the method for duly connecting the line based on the modified embodiment shown in FIG. 12 to FIG. 15 is adopted, it is not necessary that the body of the bait fish (F) is given processing such as drilling and notch for due connection. The bait fish (F) can be kept fresh and alive and, therefore, used for a prolonged period of time, because of no damage to the body of the bait fish (F). As a result, it is possible to use a live fish as the bait fish (F).

Further, as a connection ring (22) crimped so as to be folded back and fixed, the leading end (rear end) of the line (19) is, as shown in FIG. 7 to FIG. 14, coupled to an attachment ring (23) formed at a base (front end) of the hook (18) via a band (24) made with high-strength polyethylene fiber (preferably Dyneema (trade name)).

Therefore, the coupling band (24) is adjusted for an action distance thereof, thereby locking the hook (18) in the open lower edge of the vertical slit (17) of the lure body (10) from the rear end side. Next, the length in which only the sharp leading-end side of the hook (18) protrudes partially outside (below) the lure body (10) can be positioned and set appropriately constant.

However, as explained in the modified embodiment given in FIG. 11 corresponding to FIG. 9 and FIG. 10, as long as the bait fish (F) which has been inserted and set inside the hollow lure body (10) is kept enclosed at least in the anterior half segment of the lure body (10), it is acceptable that the rear end side from the virtual line (Z-Z) which connects the vicinity of the rear-end position at the dorsal fin part (16) in the lure body (10) with the vicinity of the intermediate position at the ventral part is cut out by the vertical slit (17) to keep open the posterior half segment of the lure body (10) and the hook (19) is also locked in the open lower edge of the vertical slit (17).

A reference numeral (25) indicates a certain number of rivets fixed by crimping the connection ring (22) of the line (19) so as to be folded back. Moreover, a cover tube (26) made with soft vinyl chloride for covering the rivets is inserted into the line (19).

The transparent lure (A) of the present invention is provided with the configuration which has been explained in the illustrated embodiment as a lure appropriately used for trolling tuna (fish to be caught) typical of a large-size migrant fish. Therefore, the transparent lure (A) can be used not only by professional fishermen on a fishing boat but also in special trolling in what is called sports fishing for leisure provided by using a pleasure boat (cruiser). Thus, general anglers enjoy pastime and also obtain excellent angling results as those attained by fishermen.

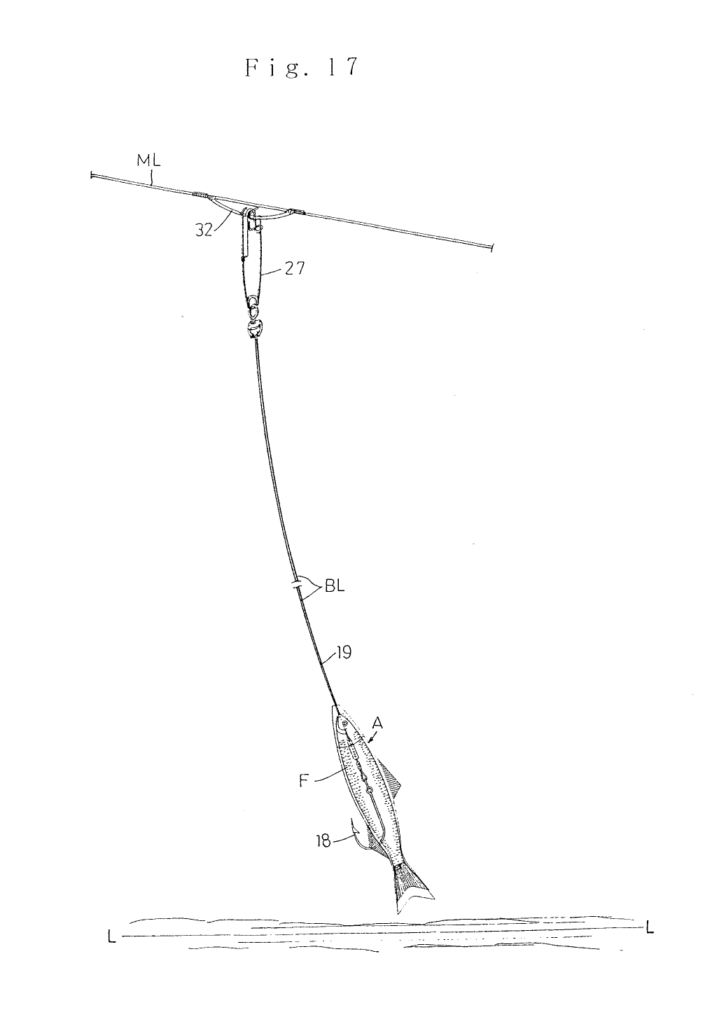

Each of FIG. 16 to FIG. 20 shows a state that the present invention is used. Where the transparent lure (A) is used in trolling tuna which is a fish to be caught, the hook (18) with which line (19) is equipped is prepared so that a bait fish (sardine) (F) to be used as live bait for the fish to be caught (tuna) is in advance inserted and set into the hollow lure body (10) as shown in FIG. 7 to FIG. 15. Moreover, the line (19) is connected in a detachable manner by its midpoint to the main line (ML) by a snap switch-type lock fitting (27) attached to the front end (base) of the branch line (BL) as an appropriately long branch line (BL) guided out from the transparent lure (A).

On the other hand, a highly elastic stick (28) (telescopic type stick in which 5 sections of rods are connected) which is made of fiber reinforced plastic (FRP) and capable of extending up to about 12 meters is attached and fixed to a cockpit deck, a flying deck or any other appropriate height on a vessel body (B) of a pleasure boat (cruiser) by setting to be about 7.35 meters in height (3-connected rod), for example. A receiver (31) of a boat rod (30) with a reel (29) attached is also attached and fixed at an appropriate position of the vessel body (B) near an angler (M).

Next, a relatively short and fixed-length (for example, about 8 meters) tag line (TL) which is finally to sag down after a fish to be caught has been caught and the main line (ML) which is much longer and appropriately long (for example, about 100 meters) are carried away from an upper end (stick tip) of the stick (28) toward offshore (backward), and a resistance board (Jumbo Bird) (JB) is attached to the leading end (rear end) of the main line (ML).

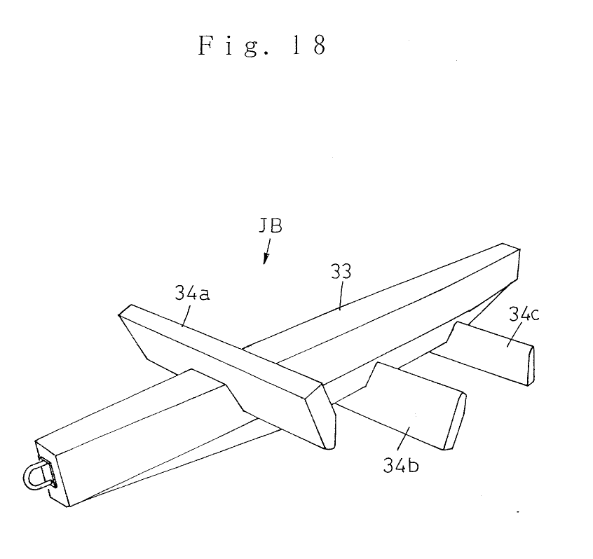

Further, by its midpoint to the main line (ML), a plurality of branch-line locking rings (32) (a total of 4 rings in this embodiment) are made at appropriately-long mutual intervals (for example, about 10 meters with each other) in the back and forth direction. Moreover, the snap opening/closing lock fitting (27) of the branch line (BL) is locked in each of the branch line locking rings (32) in a detachable manner as shown in the enlarged view of FIG. 17. Thereby, the transparent lure (A) in the preparatory state which is integrally worn on the bait fish (sardine) (F) is suspended downward from the main line (ML).

In this case, as confirmed in the overall figure of FIG. 16, an action distance of the branch line (BL) which suspends the transparent shaped lure (A) downward from the main line (ML) drawn and relatively changed the length by decreasing, for example, from about 3.5 meters-6.5 meters; about 3 meters-5 meters; about 2.5 meters-4.0 meters; to about 2.0 meters-2.5 meters sequentially in a step-wise manner, depending on what is called a backward-decreasing inclination angle of the main line (ML) extending from the upper end (stick tip) of the stick (28) toward offshore (backward). Thereby, all the plurality of transparent lures (A) (a total of 4 lures in this embodiment) are adjusted for their positions and set so as to be equal in height to the surface of the water (L-L) on average or slightly higher so that the lures will float on the surface of the water (L-L) to some extent and kept in a state that the lures do not sink into the sea.

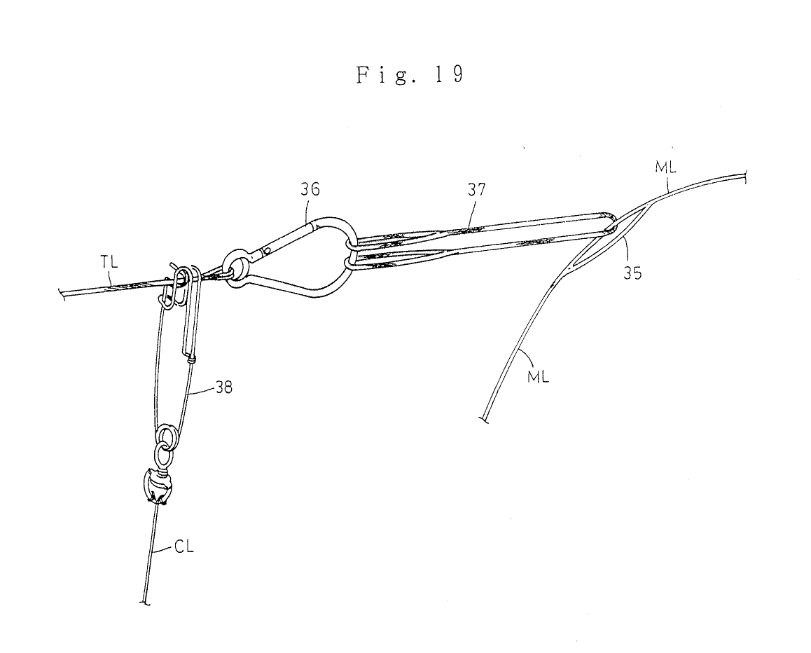

The jumbo bird (JB) is made of fiber reinforced plastic (FRP) or polypropylene and assembled in such a manner that, as shown in FIG. 18, a trunk body (33) extending only by a certain length (for example, about 1,000 mm) in the back and forth direction is orthogonal to a plurality of wing boards (34a), (34b), (34c) arranged horizontally only by a certain length (for example about 300 mm) in the lateral direction. The jumbo bird (JB) is effective in tightening straight the tag line (TL) and the main line (ML) from the stick (28) by tensile resistance including its weight (for example, about 10 kg) but also effective in gathering fish by creating actions and sounds of vigorously splashing seawater by the wing boards (34a), (34b), (34c) and allowing a tuna to sense a school of live bait fish (sardine) (F) taken by the tuna which is the target fish to be caught. The jumbo bird (JB) is not a submerged board which is dragged in water.

However, the base (front end) of the main line (ML) is kept wound around the reel (29) attached to the boat rod (30) and designed to be carried away from the reel. A breaker locking ring (35) provided on its way to the main line (ML) is coupled in a detachable manner to a snap opening/closing hook (36) tied at the leading end (rear end) of the tag line (TL) via a breaker (37) which is preferably composed of a biodegradable resin-made braided rope, as shown by an extraction of FIG. 19.

When the main line (ML) is pulled strongly from the leading end (rear end) thereof due to movement of a tuna to be caught which bites the transparent lure (A) of the branch line (BL), the breaker (37) provided on its way is broken off and automatically changed from an existing wiring system coupled to the tag line (TL) (previously existing) to a wiring system which is to be reeled by the reel (29) of the boat rod (30).

Further, a symbol (CL) indicates an auxiliary control line (action line) which is connected in a detachable manner near the leading end (rear end) of the tag line (TL). The lower end of the auxiliary control line (CL) sagging down from the tag line (TL) to the vessel body (B) is operated by being pulled or released by what is called an assistant to the angler (M) on the vessel body (B), thereby giving assistance in manually raising or lowering the transparent lure (A). A reference numeral (38) indicates a snap opening/closing lock fitting which is tied at the upper end of the auxiliary control line (CL) and the same as the lock fitting (27) of the branch line (BL).

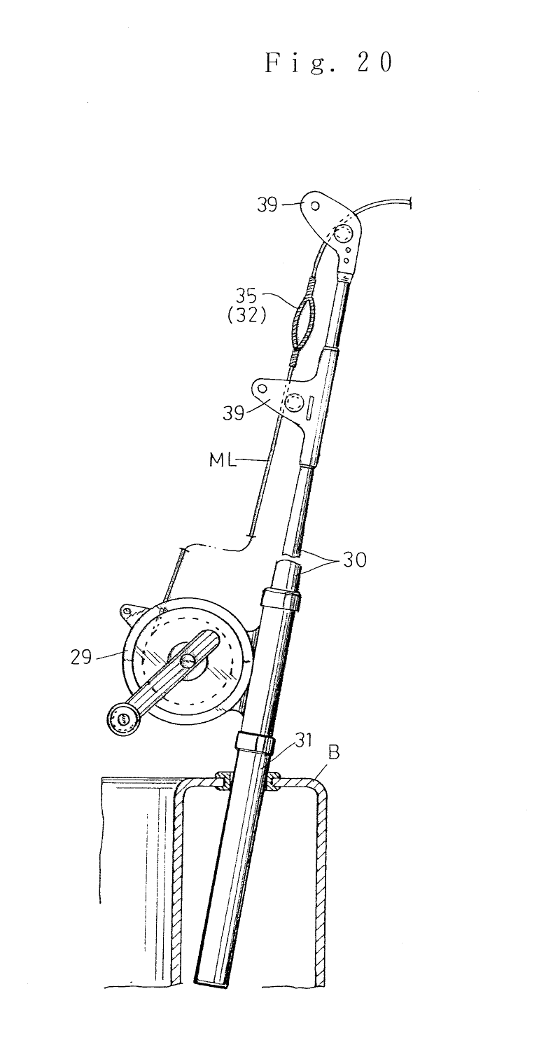

As shown in FIG. 20, the boat rod (30) to which the reel (29) of the main line (ML) is to be set so as to be inserted into a receiver (31) is fixed and installed on the vessel body (B) in a detachable manner. A reference numeral (39) indicates a plurality of main-line guide fittings installed on the boat rod (30), through which the main line (ML) having the branch line locking ring (32) and the breaker locking ring (35) can be inserted smoothly and without problem.

It is preferable that the above described flexible rope made of the above-mentioned high-strength polyethylene fiber (trade name of “Dyneema”) is adopted as the main line (ML), the tag line (TL) and the auxiliary control line (CL), while a nylon thread is adopted as the branch line (BL).

First, as apparent from numerical values of length and others which are shown as references, the above described trolling is performed in a vast area. It is, therefore, desirable that a flag (40) as a mark for notifying other boats of fishing operation in progress is attached on the tag line (TL) to secure the safety.

After the tag line (TL), the breaker (37), the main line (ML) and the jumbo bird (JB) are completely aligned straight in sequential order from the stick (28) as described above, the vessel body (B) of the pleasure boat (cruiser) is allowed to run at an appropriate speed (for example, about 5 to 8 knots) to drag the jumbo bird (JB), thus making a difference in tensile force on the main line (ML) due to the influence of wave resistance. This difference is alleviated by repulsion of the elastic stick (28), thereby quickly tightening the main line (ML) which has been loosened.

Further, when the vessel body (B) runs for operation, it causes bounding, rolling and pitching, and the upper end of the stick (28) (stick tip) sways in lateral and back-and-forth directions. The transparent lures (A) are suspended downward in parallel via the plurality of branch lines (BL) from the main line (ML), splashing the surface of the water (L-L) and jumping and hopping (floating up and down from the surface of the water) upon receiving waves or flying over the surface of the water (L-L) like flying fish, and these actions are repeated. The bait searching instinct of tuna or fish to be caught is greatly stimulated by these complicated and random actions together with sounds and light in association therewith. The bait searching instinct of tuna is also strongly stimulated by seawater vigorously splashed during dragging of the jumbo bird (JB) and sounds associated therewith. The actions contribute to fish gathering effects.

Further, the lure body (10) of the transparent lure (A) is integrally molded with a transparent thermoplastic elastomer rich in rubber-like elasticity as a hollow product approximately configured to be a bait fish (sardine) (F) which is live bait taken by fish to be caught (tuna). Thereby, an external appearance of the bait fish (sardine) (F) enclosed in the lure body can be viewed perspectively outside the lure body (10) by tuna or a fish to be caught. Further, the lure body (10) is soft in texture and light in weight and able to undergo elastic deformation freely. Thus, the bait fish (sardine) (F) and the lure body (10) which encloses the bait fish are to swim in an integrated manner. Moreover, the rear end side of the lure body (10) on which the vertical slit (17) has been cut, in particular, the caudal fin part (14) sways naturally and reliably in the lateral direction, thereby contributing to a remarkable improvement in effects that the fish to be caught (tuna) bites the lure body.

Further, the bait fish (sardine) (F) which is live bait taken by the fish to be caught (tuna) is enclosed and covered by the lure body (10) of the transparent lure (A). Therefore, there is no fear that the body of the bait fish may be damaged or collapse upon receipt of strong resistance of waves while being pulled and dragged in trolling, and the bait fish (sardine) (F) will not be detached from the lure body (10). This is effective in protecting the body of the bait fish (sardine) (F) over a prolonged period of time.

In either case, the transparent lure (A) is suspended downward from the main line (ML) via the branch line (BL) at a height substantially similar to the surface of the sea (L-L) on average or floating from the surface of the sea (L-L) to some extent. Thus, tuna, that is, a large-size migrant fish, is influenced by the above fish gathering actions to gather near the surface of the sea (surface layer) (L-L), jumping out from the water (below) and biting in particular the rear end side of the lure (A). In some cases, the lure (A) in its entirety is swallowed by the tuna.

At the time when the fish to be caught (tuna) bites the transparent lure (A), the above-described elastic stick (28) is bent and deformed rapidly like a bow from the upper end (stick tip) and also undergoes restorative deformation depending on loads thereof. Thus, there is no chance that the stick gives strong shock or resistance to the tuna, and escape from the hook or mouth cut of the tuna can be prevented by a temporal difference caused in association with the elastic deformation of the stick (28).

Further, the lure body (10) of the transparent lure (A) is a hollow product integrally molded with a thermoplastic elastomer rich in rubber-like elasticity and soft in texture and light in weight. Thus, when the tuna bites, the lure (A) is able to give the same feeling and texture as those of the bait fish (sardine) (F) and effective in preventing escape from the hook of the tuna.

Next, the tuna which has been captured by the hook (18) assembled into the lure body (10) is to pull the line (branch line) (19). Thereby, the rear end side of the transparent lure (A) is bitten off by the tuna, with the front head side thereof remaining, or the transparent lure (A) is not bitten off but left in its entirety. In either case, the lure (A) slides forward and moves along the line (19) to the front site at which the main line (ML) is present, as if being drawn away from the hook (18) (what is called, dropping of from the hook).

Further, upon receipt of strong pulling strength of the tuna which has bitten the transparent lure (A), the breaker (37) coupled with the stick (28) (stick tip) by its midpoint to the main line (ML) is cut off, and while the tag line (TL) sags down from the upper end of the stick (28), the main line (ML) is changed to a connecting system continuing to the reel (29) of the boat rod (30). Therefore, the angler (M) rotationally operates the reel (29) of the main line (ML) so that the tuna comes close to the vessel body (B) and brings it into the vessel body (B) by using a gaff or the like. Regarding the line (branch line) (19) of the transparent lure (A) at which no tuna has bitten, it is acceptable that the lock fitting (27) is removed from the main line (ML).

FIG. 16 to FIG. 20 show that special trolling is performed by using the highly elastic stick (28) developed by the present inventor as an example of the present invention. The line is paid out and extended from the end of the vessel body out at sea, or the line is paid out and extended out at sea (backward) by each of fishing poles brought outward from both sides of the vessel body. In either case, the present invention can be used in conventional trolling in general in which the transparent lure (A) of the present invention is attached by its midpoint to the line or at the leading end (rear end) thereof and the transparent lure (A) is dragged on the surface of the sea, thereby catching various types of tuna, marlin, bonito, Japanese amber jack and other large-size migrant fish near the surface of the sea (surface layer).

In the illustrated embodiment, frozen fish (thawed fish in reality) or other fresh fish is used as a bait fish (F) which is inserted and set into the hollow lure body (10) of the transparent lure (A). As long as the above-described fish can be used as live bait for fish to be caught, there may be used live fish which can move by itself.

1. A wearable transparent lure for trolling comprising
a hollow lure body that is molded with a transparent thermoplastic elastomer having rubber-like elasticity integrally into a configuration substantially similar to a bait fish which is live bait taken by fish to be caught, wherein
a fish-shaped mouth part of the lure body is formed as a line insertion hole which is communicatively connected to a mouth part of a bait fish, and at most a posterior half segment of the lure body is cut out, the bait fish which has been inserted into the hollow lure body from the cut-out rear end side is enclosed at least in an anterior half segment of the lure body, and the bait fish and the lure body are assembled in an integrated manner by allowing a line to pass through the mouth part of the bait fish and the line insertion hole of the lure body so that the line is duly connected.

2. The wearable transparent lure for trolling according to claim 1, wherein at least the anterior half segment of the lure body is elastically and firmly attached to the bait fish.

3. The wearable transparent lure for trolling according to claim 1, wherein
a vertical slit is made at most on the posterior half segment of the lure body in such a manner that the rear end side of the lure from the vertical slit sways in the lateral direction.

4. The wearable transparent lure for trolling according to claim 1, wherein
at least a caudal fin part, a dorsal fin part and an anal fin part are allowed to protrude continuously in an integrated manner from the lure body and these fin parts are surface-treated so as to give parallel linear irregularities, intersecting linear irregularities or satin-like irregularities in which dots are scattered.

5. The wearable transparent lure for trolling according to claim 1, wherein
a line to which a hook has been attached integrally at the rear end thereof is allowed to pass from the cut-out rear end side of the lure body through the body of the bait fish into the line insertion hole of the lure body so that the line is duly connected, and only the sharp leading-end side of the hook is allowed to protrude partially outside the lure body.

6. The wearable transparent lure for trolling according to claim 1, wherein
a line to which a hook has been attached integrally at the rear end thereof is allowed to pass from the cut-out rear end side of the lure body through a gill part of the bait fish, the mouth part thereof and the line insertion hole of the lure body so that the line is duly connected, and only the sharp leading-end side of the hook is allowed to protrude partially outside the lure body.

7. A method of producing a wearable transparent lure for trolling, comprising
molding a hollow lure body with a transparent thermoplastic elastomer having rubber-like elasticity integrally into a configuration substantially similar to a bait fish which is live bait taken by fish to be caught, wherein a fish-shaped mouth part of the lure body is formed as a line insertion hole which is communicatively connected to a mouth part of a bait fish, and at most a posterior half segment of the lure body is cut out,
inserting the bait fish into the hollow lure body from the cut-out rear end side so that the bait fish is enclosed at least in an anterior half segment of the lure body, and
assembling the bait fish and the lure body in an integrated manner by allowing a line to pass through the mouth part of the bait fish and the line insertion hole of the lure body so that the line is duly connected.
